(19) United States
(12) Patent Application Publication
(10) Pub. No.: US 2005/0262703 A1
(43) Pub. Date: Dec. 1, 2005

(54) Slicing apparatus including rotatably attached rigid blade and roller

(76) Inventors: James Joseph Best, Weehawken, NJ (US); Timothy Jude Kennedy, Staten Island, NY (US)

Correspondence Address: SEYFARTH SHAW LLP, 55 EAST MONROE STREET, SUITE 4200, CHICAGO, IL, 60603-5803, US

(21) Appl. No.: 10/858,015

(22) Filed: Jun. 1, 2004

(51) Int. Cl. A01D 1/00

(52) U.S. Cl. 30/279.6

(57) ABSTRACT

A food slicing apparatus. The apparatus includes a handle. A rigid blade and a roller are rotatably mounted to the handle. The rigid blade may include a reinforcing rib positioned thereon.

### BACKGROUND

This application relates generally to slicing apparatuses and more specifically, to bladed food slicing apparatuses.

Food slicers, such as cheese and fruit or vegetable slicers, are a common kitchen implement. Often these comprise a handle and a slicing wire. A user holds the slicer by the handle and applies downward pressure while sliding the wire through a piece of cheese or fruit to slice. After a number of uses, however, the wire often breaks; thus, rendering the slicer useless.

Some vegetable peelers include a handle and a blade, but these are not designed to produce slices of a food. Instead, they merely peel the skin off of a food surface. Moreover, vegetable peelers are unable to cut through thick heavy foods, such as certain cheeses, without their blades bending or even breaking. These peelers are also not equipped with rollers, which serve as a guide to aid the user when cutting a piece of food.

Accordingly, what is needed is a slicing apparatus that is capable of repeated use with varying types of food without the blade bending or breaking.

### SUMMARY

There is disclosed in this application a slicing apparatus, including a rotatable rigid blade.

In one example, the slicing apparatus includes a handle, a rigid blade rotatably mounted to the handle, and a roller rotatably mounted to the handle.

In another example, the slicing apparatus includes a handle and a blade attached to the handle. The blade includes at least one reinforcing rib positioned thereon.

### BRIEF DESCRIPTION OF THE DRAWINGS

FIG. 1 is a perspective view of one example of a slicing apparatus including a rigid blade;

FIG. 2 is a top view of the slicing apparatus of FIG. 1;

FIG. 3 is a slightly reduced exploded, perspective view of the slicing apparatus of FIG. 1;

FIG. 4 is an enlarged, fragmentary, perspective, detailed view of a portion of the underside of the blade shown in FIG. 1; and

FIG. 5 is an enlarged, fragmentary, cross-sectional view taken generally along line 5-5 of FIG. 2.

### DETAILED DESCRIPTION

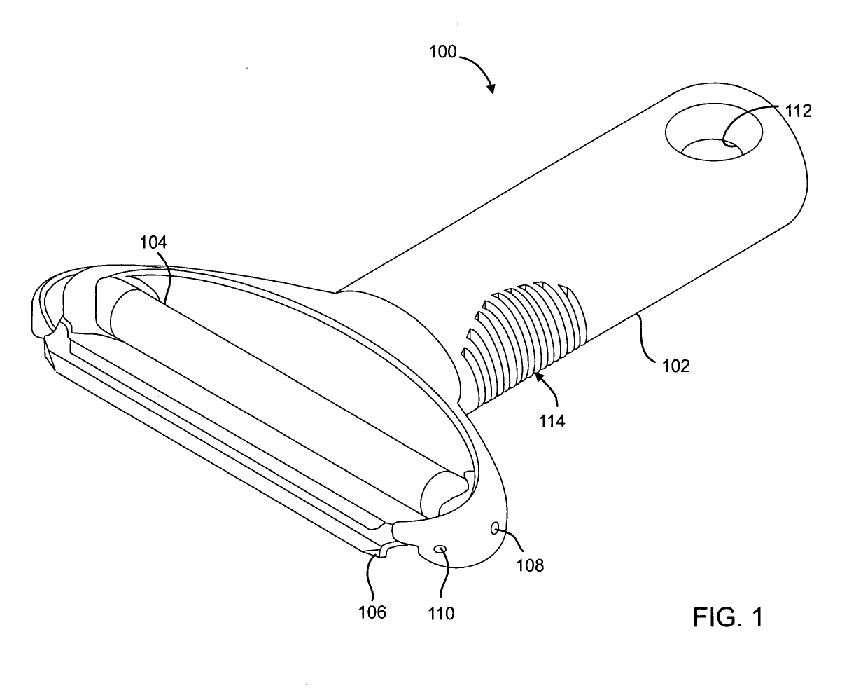

Referring to FIG. 1, in one example, slicing apparatus 100 comprises a handle 102, roller 104, and rigid blade 106. Both roller 104 and blade 106 are rotatably mounted to handle 102. Handle 102, roller 104, and blade 106 can be made of the same or different materials. For example, they each could be made of the same material, such as a metal (e.g. diecast zinc or stainless steel), plastic (e.g. polypropylene), or rubber. Alternatively, handle 102, roller 104, and blade 106 could be made of different combinations of these materials. Each part could comprise one or more of these materials. For instance, handle 102 could be made of a combination of a metal and one or more plastics, or could have a rigid plastic core overmolded with an elastomeric material, and roller 104 could have a plastic core covered by metal, or vice verso. The preceding description of the materials is for illustrative purposes only and is not meant to limit the present application. The particular materials used to form slicing apparatus 100 are important insofar as they provide sufficient support to allow roller 104 and blade 106 to operate effectively to slice food.

Roller 104 and blade 106 are rotatably mounted to the handle 102 through the use of pivot pins 108, 110, which are positioned in holes located on both handle 102, roller 104, and blade 106. Handle 102 also includes hole 112 and gripping surface 114. Hole 12 is utilized to hang slicing apparatus 100 from a hook or to insert a strap or wire to hang slicing apparatus 100 from a hook, or to wrap around the user's wrist. Gripping surface 114 prevents slicing apparatus from slipping in an end user's hand.

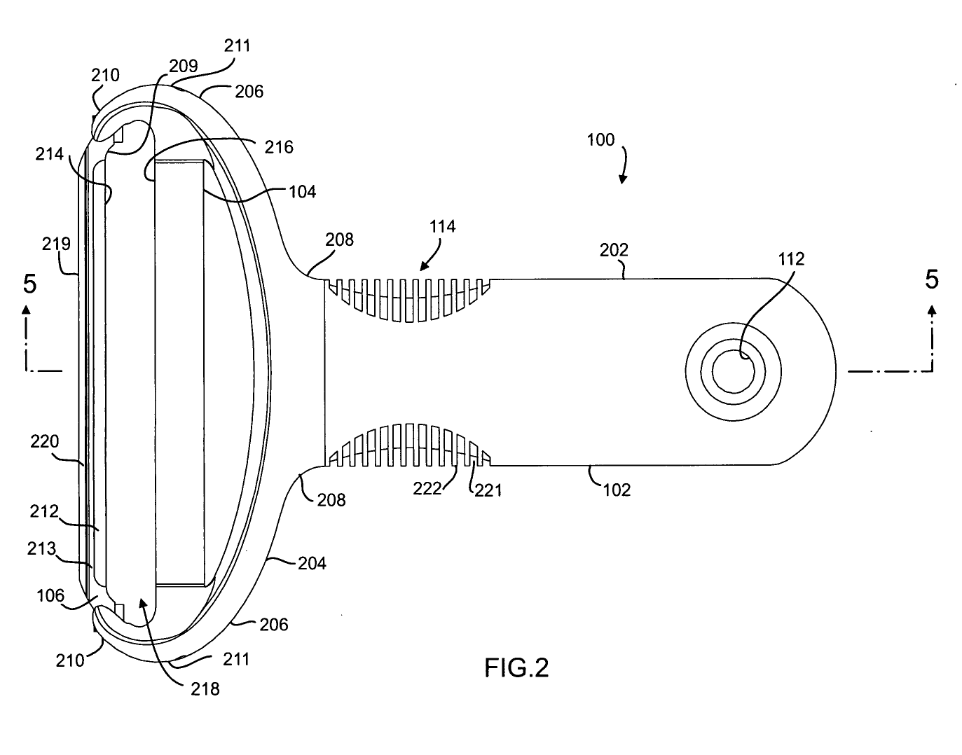

Referring to FIG. 2, handle 102 in one example, comprises a support member, such as grip portion 202 and yoke 204. Yoke 204 supports roller 104 and blade 106. Grip portion 202 and yoke 204 can be made of the same material and integrally connected, or the two can be made of different materials. For instance, grip portion 202 could be made of plastic and yoke 204 could be made of diecast zinc.

Yoke 204 includes two arms 206 each having a first end 208 attached to grip portion 202 and a second end 210. Arms 206 extend out from grip portion 202 in a spaced apart configuration. Accordingly, grip portion 202 and yoke 204 form a generally “Y” shape. In one example, roller 104 is positioned between arms 206 at an approximate midpoint 211 and blade 106, in one example, is positioned between ends 210. The configuration shown is not limiting. Handle 102 could have a variety of shapes, provided that roller 104 and blade 106 are positioned in a configuration operative to allow slicing of food.

Referring still to FIG. 2, one side 209 of blade 106 includes a cutting surface 212. In one example, the plane of cutting surface 212 declines at an angle relative to a plane of the top surface 213 of blade 106. Cutting surface 212 includes a sharpened edge 214 that actually cuts the food. Edge 214 and external surface 216 of roller 104 combine to form a channel 218. A user cuts a particular food, such as a block of cheese, by using handle 102 to guide roller 104 across the surface of the block, while blade 106 is driven through the cheese. Roller 104 acts as a guide while blade 106 is drawn through the cheese. The pivoting or rotational aspect of blade 106 allows blade 106 to maintain contact with the surface of the cheese, even if the cheese contains bumps or is not flat (e.g. a circular block of cheese). As slicing apparatus 100 is drawn across the cheese, cutting edge 214 lifts a slice off the block. The pivotal mounting of the blade facilitates this action. The cheese slice then exits from channel 218 where the user grasps it.

A second side 219 of blade 106 includes a reinforcing rib 220 positioned on at least a portion thereof. Reinforcing rib 220 serves to reinforce blade 106 such that slicing apparatus 100 can slice foods of varying hardness, for example, when slicing hard cheeses, rib 220 prevents blade 106 from bending or breaking.

Referring still to FIG. 2, gripping surface 114, in one example, comprises a plurality of alternating indentations 221 and ridges 222 formed in grip portion 202. Indentions 221 and ridges 220 combine to provide a surface that will inhibit slipping of a user's thumb or forefinger.

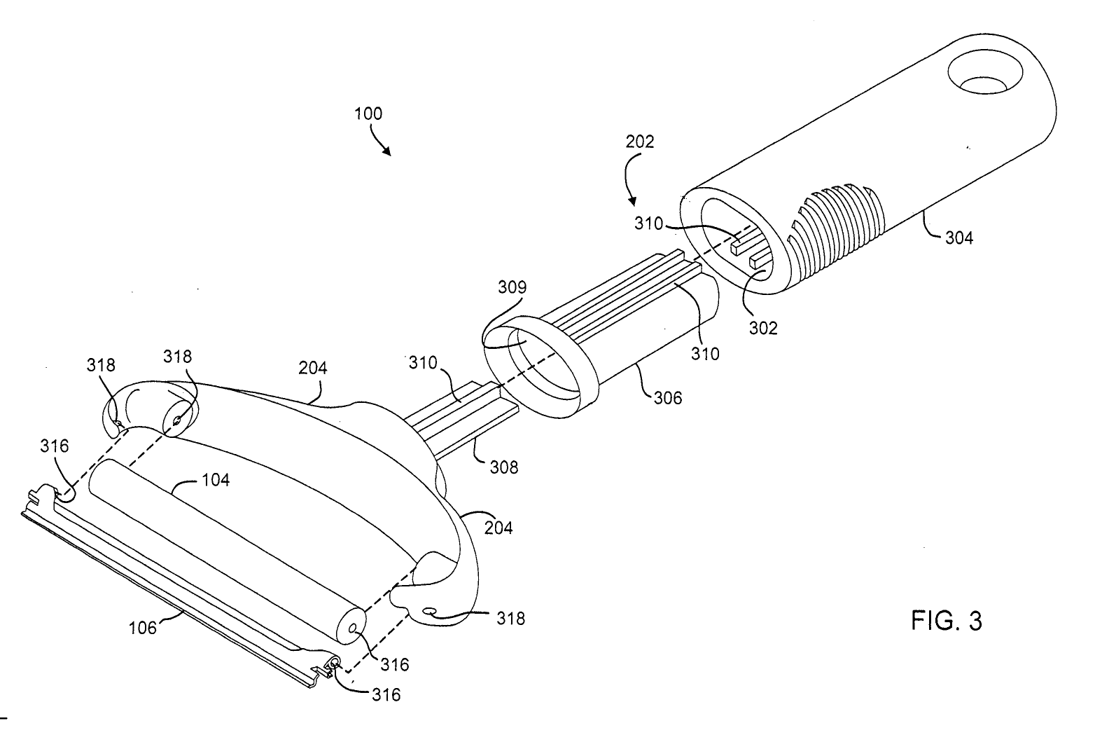

Referring to FIG. 3, an exploded view of slicing apparatus 100 is provided for illustrative purposes. In the example of FIG. 3, grip portion 202 is made of three pieces: shell 302, cover 304, and insert 306, while yoke 204 is made of one piece.

Referring further to FIG. 3, in one example shell 302, and insert 306 are made of plastic and cover 304 is made of rubber or an elastomeric material. Alternatively, each component could be made of the same material. The components could also be made of materials other than rubber and plastic. Cover 304 is frictionally fit to surround shell 302 and provides an appropriate external surface for gripping by the user. Shell 302 and insert 306 are the press fit together to form grip portion 202.

Yoke 204 is attached to grip portion 202 by inserting neck 308 into recess 309 of insert 306. Yoke 204 and insert 306 may be press fit together. Guides 310 can be provided on shell 302, insert 306, and neck 308 to help position the three when they are press fit. It should be noted, however, that shell 302, insert 306 and yoke 204 do not have to be press fit together. Other means could be used to attach shell 302, insert 306, and neck 308 (e.g. adhesives, pins, screws, etc).

Roller 104 and blade 106 include holes 316 which are positioned in registration with corresponding holes 318 of yoke 204. Pins (shown in FIG. 1) are inserted in holes 316, 318 to secure roller 104 and blade 106 to yoke 204, and to accommodate rotational or pivotal movement of the roller 104 and blade 106 about the axis of the pins.

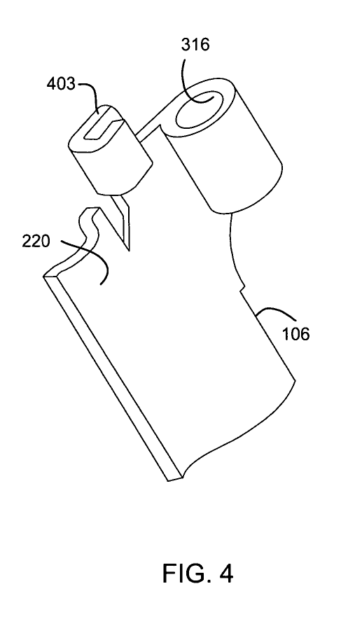

Referring to FIG. 4, an underside view of a portion of one side of blade 106 is shown for illustrative purposes. Reinforcing rib 220 is shown integrally formed with blade 106. As an alternative, rib 220 could be added after manufacture of blade 106, for example by welding or with an adhesive.

Hole 316, in one example, is integrally formed by doubling a portion of blade 106 back upon itself. Hole 316, alternatively, could be formed in a sleeve or bushing made of a second material, such as plastic, and attached to blade 106 through some means, such as an adhesive.

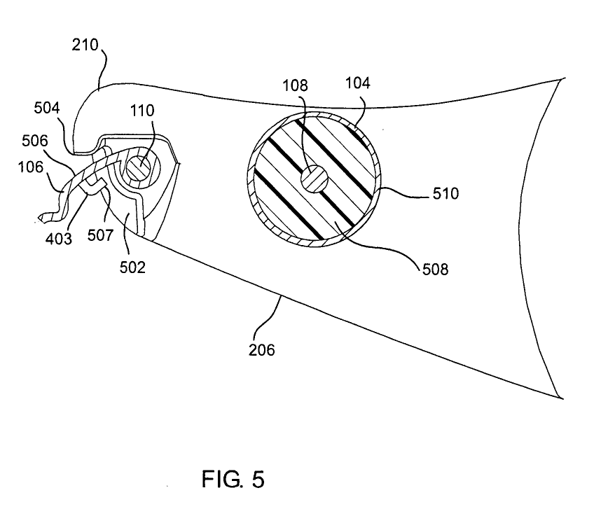

Referring now to FIGS. 4 and 5, blade 106, in one example, also includes tab 403. Tab 403 is utilized to limit the rotational motion of blade 106. Referring to FIG. 5, end 210 of each arm 206 includes an inward protruding portion 502 and a downward protruding portion 504. Blade 106 rotates from a first position, in which a first side 506 of blade 106 abuts downward protruding portion 502, and a second position, in which a finger 507 of tab 403 abuts inward protruding portion 502. In one example, blade 506 rotates through a range of approximately 30 to 40 degrees, although this range of motion is not meant to be limiting. The range of motion can be adjusted depending on the needs of the manufacturer, seller, or end user. For example, tab 403 could be removed or straightened to increase the range of motion. Similarly, tab could be enlarged to decrease the range of motion.

Referring further to FIG. 5, in the example shown, roller 104 is made of two materials: A plastic core 508 covered with another material 510, such as die cast metal or stainless steel. In another example, roller 104 could be made entirely of one material.

The matter set forth in the foregoing description and accompanying drawings is offered by way of illustration only and not as a limitation. While particular embodiments have been shown and described, it would be apparent to those skilled in the art that changes and modifications may be made without departing from the broader aspects of applicant's contribution. The actual scope of the protection sought is intended to be defined in the following claims, when viewed in their proper perspective based on the prior art.

1. A slicing apparatus, comprising:
a handle;
a rigid blade rotatably mounted to the handle;
a reinforcing rib positioned on the blade; and
a roller rotatably mounted to the handle.

2. The slicing apparatus of claim 1, wherein the handle comprises:
a support member; and
a yoke portion having two arms, each arm having a first end attached to the support member and a second end extending out from the support member.

3. The slicing apparatus of claim 2, wherein the support member and the yoke portion form a “Y” shape.

4. The slicing apparatus of claim 2, wherein the support member and the yoke portion are integrally connected.

5. The slicing apparatus of claim 2, wherein the arms are spaced apart.

6. The slicing apparatus of claim 5, wherein the roller and the rigid blade are positioned between the arms.

7. The slicing apparatus of claim 2, wherein the yoke portion and the support member are each made of at least one of a die cast metal and a plastic.

8. The slicing apparatus of claim 2, wherein the handle further comprises a plastic sleeve surrounding the support member.

9. The slicing apparatus of claim 2, wherein the blade and the roller each have an axis of rotation that is approximately perpendicular to a longitudinal axis of the support member.

10. The slicing apparatus of claim 9, wherein the blade rotates up to 40 degrees relative to a plane defined by the support member.

11. The slicing apparatus of claim 1, wherein the blade is made of stainless steel.

12. The slicing apparatus of claim 1, wherein the blade includes a first edge having a cutting surface forged thereon.

13. The slicing apparatus of claim 12, wherein an edge of the cutting surface and a surface of the roller form a channel for receipt of an item to be sliced.

14. (canceled)

15. The slicing apparatus of claim 14, wherein the reinforcing rib extends along at least a portion of a second edge of the blade.

16. A slicing apparatus, comprising:
a handle;
a rigid blade rotatably attached to the handle, wherein the rigid blade includes a top surface, a bottom surface, and a cutting surface positioned at an angle relative to the top surface and the bottom surface.

17. The slicing apparatus of claim 16, wherein the handle comprises a support member and a yoke portion having two arms extending out from the support member in a spaced apart configuration.

18. The slicing apparatus of claim 17, wherein the blade is rotatably mounted between the two arms.

19. The slicing apparatus of claim 18, wherein the blade pivots up to approximately 40 degrees relative to a plane of the support member.

20. The slicing apparatus of claim 16, wherein the blade includes a first side having a cutting surface forged thereon and a second side on which the reinforcing rib is positioned.

21. The slicing apparatus of claim 20, wherein the reinforcing rib comprises a ridge that extends longitudinally along the second side.

22. The slicing apparatus of claim 21, wherein the reinforcing rib and the blade are integrally connected.

23. The slicing apparatus of claim 16, wherein the blade is made of stainless steel.
